(19) United States
(12) Patent Application Publication
(10) Pub. No.: US 2009/0204407 A1
(43) Pub. Date: Aug. 13, 2009

(54) System and method for processing a spoken request from a user

(76) Inventors: T. Russell Shields, Chicago, IL (US); Bruno Philippe Simon, gif sur Yvette (FR); John F. Guzolek, Fremont, CA (US)

Correspondence Address: BRINKS HOFER GILSON & LIONE, P.O. BOX 10395, CHICAGO, IL, 60610, US

(21) Appl. No.: 12/069,290

(22) Filed: Feb. 8, 2008

(51) Int. Cl. G10L 21/00

(52) U.S. Cl. 704/270.1

(57) ABSTRACT

A system and method are described for processing a spoken request from a user. In one embodiment, a method is disclosed for attempting to recognize a spoken request from a user with a speech recognition engine above a predetermined level of accuracy. If the spoken request is not recognized above the predetermined level of accuracy, the spoken request is provided to a level one agent. If the level one agent does not recognize the request, a voice connection is established between the user and a level two agent. In another embodiment, a method is disclosed for determining whether a silent response system recognizes a spoken request from a user above a predetermined level of accuracy. A response is provided to the user if the silent response system recognizes the spoken request. Otherwise, a voice connection is established between the user and a call center.

### BACKGROUND

The management of information requests from users in interactive voice systems may be handled by conventional call center operators. However, the interaction between the user and the call center is often slow and expensive. Successful interactive voice systems depend on efficient and accurate recognition of information requests from system users. Thus, inaccurate or slow speech recognition may deter users from using the interactive voice system.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for processing a spoken request from a user.

FIG. 2 is a block diagram of an implementation of the system of FIG. 1 or other systems for processing a spoken request from a user.

FIG. 3 is a block diagram of the integration framework of the system of FIG. 1 or other systems for processing a spoken request from a user.

FIG. 4 is a flowchart illustrating the operations of utilizing two levels of agents in the system of FIG. 1, or in other systems for processing a spoken request from a user.

FIG. 5 is a flowchart illustrating the operations of using one level of agents in the system of FIG. 1, or in other systems for processing a spoken request from a user.

FIG. 6 is a block diagram of a multi-tier implementation of the system of FIG. 1 or other systems for processing a spoken request from a user.

FIG. 7 is an illustration a general computer system that may be used in the systems of FIG. 1, 2, 3, or 6, or other systems for processing a spoken request from a user.

### DETAILED DESCRIPTION

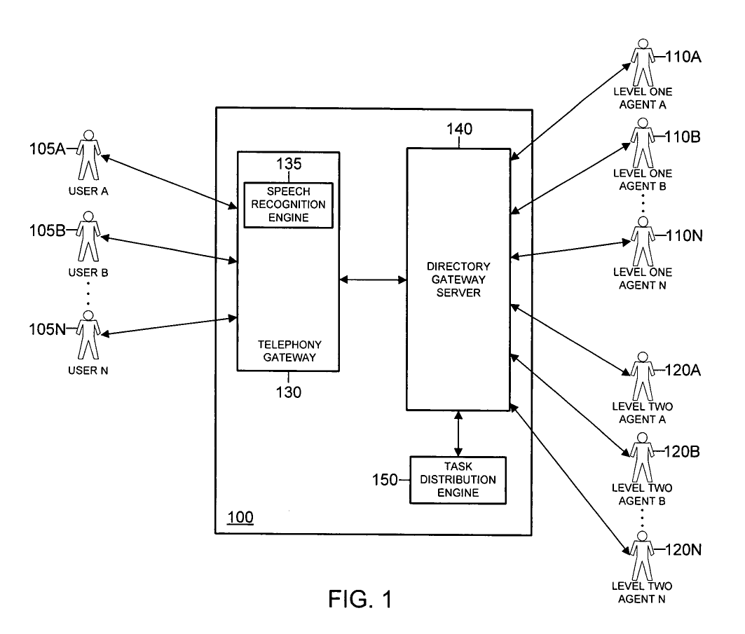

FIG. 1 provides a general overview of a system 100 for processing a spoken request from a user. Not all of the depicted components are required, however, and some implementations may include additional components. Variations in the arrangement and type of the components may be made without departing from the spirit or scope of the claims as set forth herein. Additional, different or fewer components may be provided.

The system 100 in this embodiment includes a task distribution engine 150, a directory gateway server 140, and a telephony gateway 130. The telephony gateway 130 includes a speech recognition engine 135. One or more users 105A-N, level one agents 110A-N, and level two agents 120A-N interact with the system 100. As will be described in more detail below, in embodiments wherein the level one agent and level two agent are different people, the level one agent typically does not have voice communication with the user. However, in embodiments where the level one agent and level two agent are the same person, the person would not have voice communication with the user in his role as a level one agent but would have voice communication with the user in his role as a level two agent.

In operation, the telephony gateway 130 may receive a spoken request from the user A 105A. The speech recognition engine 135 attempts to recognize the spoken request and determines whether the spoken request can be recognized above a predetermined level of accuracy. If the speech recognition engine 135 does not recognize the spoken request above the predetermined level of accuracy, the spoken request is provided to the level one agent A 110A via the directory gateway server 140. If the level one agent A 110A does not recognize the spoken request, a voice connection is established between the user A 105A and the level two agent A 120A. Alternatively or in addition, a data connection may be established between a mobile device associated with the user A 105A, such as a mobile phone or a telematics system of a vehicle, and the level two agent A 120A. The level one agent A 110A may have a predetermined time interval to recognize the spoken request before a voice connection is established with the level two agent A 120A.

If the spoken request is recognized by one of the speech recognition engine 135, the level one agent A 110A, and the level two agent A 120A, the system 100 provides a response to the spoken request to the user A 105A. The response may include one of a voice response, a data response, a combined voice and data response, or an action, such as remotely unlocking a vehicle or providing a request for information to a content provider database. The request for information to a content provider database may be formatted the same irrespective of whether the spoken request is recognized by the speech recognition engine 135, the level one agent A 110A, or the level two agent A 120A.

Service providers of an interactive voice system may use the system 100 to decrease cost and response time and provide quick and accurate speech recognition to the users 105A-N. The functional separation of the agents 110A-N, 120A-N into level one agents 110A-N, and level two agents 120A-N, allows a service provider to implement a cost efficient call center architecture. The level one agents 110A-N only need to be able to recognize the language spoken by the users 110A-N. The level one agents 110A-N do not need to be able to speak the language spoken by the users 110A-N. Thus the reduced skillset of the level one agents 110A-N may result in more cost efficient labor than the level two agents 120A-N. The system 100 allows a service provider to utilize the cost efficient level one agents 110A-N for the majority of the speech recognition tasks and only use the potentially more costly level two agents 120A-N when the level one agents 110A-N are not capable of performing the speech recognition task.

The system 100 allows a service provider of an interactive voice system to reduce call center infrastructure cost by allowing the service provider to implement a distributed or work at home model for the agents 110A-N, 120A-N. For example the agents 110A-N, 120A-N may be located remotely from each other and/or from the system 100. The level one agents 110A-N may be located in a call center geographically remote from the level two agents 110A-N. For example, the level one agents 110A-N may be located in a geographic area that provides lower cost labor, business tax exemptions, or other incentives for maintaining a business presence, such as a call center. The system 100 also allows the agents 110A-N, 120A-N to work from their homes, eliminating the need for a physical call center altogether.

The system 100 allows a service provider to route voice connections to level two agents 110A-N who share a regional or local dialect with the users 105A-N. For example a user A 105A with a regional dialect from the United Kingdom may access the system 100 from the United States. If an information request from the user A 105A is routed to the level one agents 110A-N, any level one agent 110A-N that is capable of understanding the English language could handle the request, regardless of whether the level one agents 110A-N speak with a dialect from the United Kingdom. If a level one agent A 110A is incapable of recognizing the request, the request is routed to a level two agent A 120A. Since the user A 105A has a regional dialect from the United Kingdom, the user A 105A may be more comfortable conversing with a level two agent A 120A with a United Kingdom dialect. In addition, a level two agent A 120A with the same dialect as the user A 105A may be more efficient at determining the information requested by the user A 105A.

The system 100 may be implemented by any provider of an interactive voice system. For example, a provider of an interactive voice system for use in vehicles could utilize the advantages of the system 100. In such a vehicle system, the driver of the vehicle (or a passenger) requests information from the system, such as directions, points of interests, remaining fuel, tolls ahead, or generally any information pertinent to the location or operation of the vehicle. The driver may also provide spoken commands to the system, such as “turn on headlights,” “call home,” or generally any command useful to the driver of a vehicle. The provider may also implement a phone based interactive voice response system. For example, a user A 105A makes a phone call into the service and navigates the menus of the service provider by providing voice commands. In general, the service provider may provide any voice system which recognizes spoken requests, or commands, from a user A 105A.

In the case of an implementation of the system 100 incorporating mapping and location elements, such as in a vehicle, the service provider may connect a user A 105A with a level two agent A 120A where the level two agent A 120A has local knowledge relevant to the current location of the user A 105A. If the level two agent A 120A has local knowledge the level two agent A 120A may be better able to assist the user A 105A obtain the requested information.

The users 105A-N may be a driver in a vehicle, a person calling from a home phone, a person interacting with a VoIP system, or generally any person requesting information through a spoken request. Alternatively, the users 105A-N may request information through a text based request, such as a web request, an email request, a mobile message request or generally any text based request. In the case of users 105A-N who are drivers in vehicles, the users 105A-N may interact with a telematics subsystem. The telematics subsystem provides location information, mapping information, driving directions, information regarding points of interest, or generally any data pertaining to operating a vehicle. The telematics subsystem receives voice requests from a user A 105A and the telematics subsystem provides voice responses to the user A 105A. The telematics subsystem also may provide visual map data to the user A 105A via a mobile device of the user A 105A or a display in the vehicle.

The level one agents 110A-N may be any persons capable of recognizing phrases spoken in the language of the users 105A-N. Since the level one agents 110A-N do not speak with the users 105A-N, the level one agents 105A-N do not need to be fluent in the language of the users 105A-N, or even be able to speak the language of the users 105A-N. The level one agents 110A-N may be located in a call center or may be located remotely, such as at their home. The system 100 may store a list of languages and dialects that each of the level one agents 110A-N is capable of understanding.

The level two agents 120A-N should be fluent in the language of the users 105A-N. In order to provide better service to the users 105A-N, the level two agents 120A-N may also be able to speak in the local dialect of the users 105A-N. The system 100 may store a list of the languages and dialects that each of the level two agents 120A-N is capable of speaking. The level two agents 120A-N may be physically located in a call center with the level one agents 110A-N, may be located in a separate call center, or may be located remotely, such as at their home.

The speech recognition engine 135 may be any speech recognition engine such as, the LUMENVOX SPEECH ENGINE, the NUANCE VOCON 3200, the NUANCE VOCON SF, IBM EMBEDDED VIAVOICE, or generally any application capable of recognizing speech. The system 100 should provide accuracy and response time at least as good as a traditional call center operation, and ideally should reduce the response time and increase accuracy. The speech recognition engine 135 should recognize a request from the user A 105A, within a predetermined time, such as 3-5 seconds. If the speech recognition engine 135 exceeds this time limit, the request is passed to one of the agents 110A-N, 120A-N. In the instance where a user A 105A of the system 100 is a driver of a vehicle, the system 100 may incorporate additional technology to limit the background noise in the vehicle.

The telephony gateway 130 may be any telephony gateway, such as the DIGIUM ASTERISK, the PINGTEL SIPXCHANGE, FREESWITCH, or generally any application that provides the functionality of a private branch exchange (“PBX”). The telephony gateway 130 should be capable of supporting mobile phone calls, landline phone calls, voice over internet protocol (“VoIP”) calls, or generally any audio based transmission. The directory gateway server 140 is capable of facilitating communications between the components in the system 100 and the agents 110A-N, 120A-N. The directory gateway server 140 may utilize technology described in co-pending U.S. patent application Ser. No. 11/512,899 entitled “Order Distributor,” the disclosure of which is incorporated herein by reference, to implement the distributed architecture of a call center.

The task distribution engine 150 is an application that is capable of tracking and maintaining the availability of the agents 110A-N, 120A-N. The task distribution engine 150 maintains the languages and dialects the agents 110A-N, 120A-N are capable of comprehending and/or speaking. The task distribution engine 150 also maintains the current location of the agents 110A-N, 120A-N, such as through an internet protocol address (“IP address”) or through a JABBER identifier. The system 100 utilizes an extensible messaging and presence protocol (“XMPP”) to coordinate communications between the components of the systems and the agents 110A-N, 120A-N. In one implementation the system 100 may use JABBER MESSAGING to facilitate communications between the agents 110A-N, 120A-N and the system 100.

In operation, the system 100 may be implemented with any combination of one or more of the speech recognition engine 135, the level one agents 110A-N and the level two agents 120A-N. For example, the speech recognition engine 135 may not be an essential component and the system 100 may operate with level one agents 110A-N and level two agents 120A-N, and without a speech recognition engine 135. Alternatively, the system 100 may incorporate only a speech recognition engine 135 and level two agents 120A-N. In this instance the level two agents 120A-N may perform the role of the level one agents 110A-N. For example, the level two agents 120A-N first determine whether they can recognize the content of the spoken request without interacting directly with the user A 105A. If they can not recognize the spoken request, the system 100 then establishes a voice connection between a level two agent A 120A and a user A 105A.

In the case of a user A 105A who is a driver of a vehicle, the speech recognition engine 135 will ideally interact as little as possible with the user A 105A so as to not distract the user A 105A from driving. Specifically, there should be no lengthy question/prompt/exchange related to the speech recognition engine 135, and the speech recognition engine 135 should be optimized to recognize words and phrases that are typically spoken by drivers of vehicles. In other implementations, the speech recognition engine 135 may be configured to recognize words commonly associated with the particular implementation.

Once the system 100 recognizes the request, the system 100 interfaces with a content provider database to retrieve data related to the request. The system 100 makes a request to the content provider database for data related to the spoken request. Ideally, the request to the content provider database is the same regardless of whether it is initiated by the speech recognition engine 135, a level one agent A 110A, or a level two agent A 120A. The request to the content provider database may also include data describing the current location of the user A 105A. Thus, the data retrieved from the content provider database may relate to both the current location of the user A 105A and the spoken request.

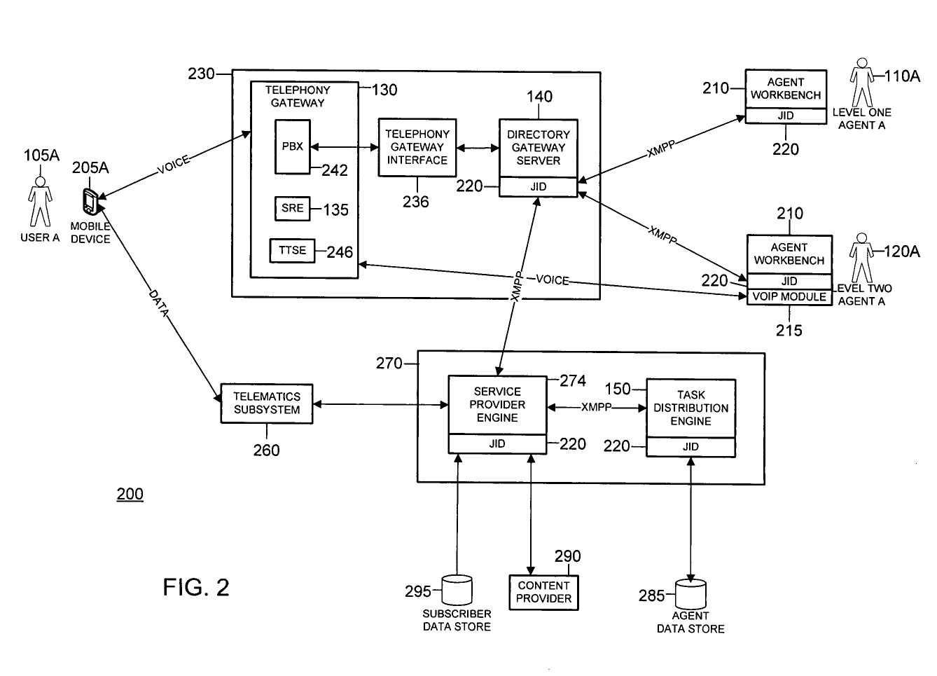

FIG. 2 illustrates an implementation 200 of the system of FIG. 1, or other systems for processing a spoken request from a user. Not all of the depicted components are required, however, and some implementations may include additional components. Variations in the arrangement and type of the components may be made without departing from the spirit or scope of the claims as set forth herein. Additional, different or fewer components may be provided.

The implementation 200 in this embodiment includes a user A 105A, a level one agent A 110A, a level two agent A 120A, a mobile device A 205A, one or more agent workbenches 210, one or more JABBER identifiers (“JID”) 220, a VoIP module 215, a gateway system 230, a service provider system 270, a telematics subsystem 260, a content provider 290, a subscriber database 295, and an agent data store 285. The gateway system 230 includes a telephony gateway 130, a telephony gateway interface 236, and a directory gateway server 140. The telephony gateway 130 includes a private branch exchange (“PBX”) 242, a speech recognition engine (“SRE”) 135, and a text to speech recognition engine (“TTSE”) 246. The service provider system 270 includes a service provider engine 274 and a task distribution engine 150.

The agent workbenches 210 are thin client software interfaces that allow the agents 110A-N, 120A-N to interact with the system 100. The agents 110A-N, 120A-N access the agent workbenches 210 through a web browser, a standalone application, or a mobile application. The agent workbenches 210 may also incorporate an interface to the content provider 290. The interface to the content provider 290 provides the agents 110A-N, 120A-N with access to data from the content provider 290. The agent workbenches 210 also include a VoIP module 215. The VoIP module facilitates the level two agents 220A-N in establishing a voice connection with the users 120A-N.

Each of the components in the system 100, and the agents 110A-N, 120A-N, may be associated with a JABBER identifier 220. The JABBER identifiers 220 allow the components of the system 100, and the agents 110A-N, 120A-N, to easily address and communicate messages to one another. The JABBER identifiers 220 eliminate the need for tracking the IP address of each component and each of the agents 110A-N, 120A-N. Once a component and/or agent A 110A is logged in, the other components and agents 110B-N, 120A-N may address messages to the component and/or agent A 110A using the JABBER identifier 220. The other components and/or agents 110B-N, 120A-N do not need to know the internet protocol (“IP”) address of the agent A 110A.

The telematics subsystem 260 may include an automotive navigation system that incorporates a positioning system, such as a global positioning system (“GPS”), an EU Global Navigation Satellite System (“GNSS”), a BEIDOU positioning system a GALILEO positioning system, a COMPASS positioning system, a GLONASS positioning system, an Indian Regional Navigational Satellite System (“IRNSS”), a QZSS positioning system, or generally any positioning system capable of determining the location of a vehicle. The telematics subsystem 260 may provide maps, local data, points of interest, traffic information, or generally any information of interest to a driver in a vehicle. The information may be displayed to a user A 105A on a display in the vehicle, or on a mobile device 205A of the user A 105A. A mobile device 205A of the user A 105A may communicate with the telematics subsystem 260 via the BLUETOOTH protocol. The telematics subsystem 260 may also communicate information audibly to the user A 105A.

In the operation of the system 100 implemented for users 105A-N who are drivers of a vehicle, a user A 105A may click on a button in the vehicle to initiate operation of the system 100. The button opens a data connection between the vehicle and the telematics subsystem 260. The data connection may be initiated by the mobile device A 205A of the user A 105A, or by a device incorporated into the vehicle. The current location of the user A 105A is communicated to the subsystem 260 via the data connection. The telematics subsystem 260 communicates the location of the user A 105A to the service provider engine 274. The user A 105A can be identified by the phone number of the mobile device 205A that established the data connection. The service provider engine 274 can verify that the user A 105 is a subscriber to the service by looking up the phone number in the subscriber data store 295. If the user A 105A is not a subscriber to the service, requests from the user A 105A may be blocked.

After the location of the user A 105A has been communicated to the telematics subsystem 260, the system 100 may establish a voice connection with the mobile device A 205A through the telephony gateway 130, or with a device incorporated into the vehicle of the user A 105A. The user A 105A submits a spoken request for information to the system 100, such as “where is the nearest Chinese restaurant.” The speech recognition engine 135 of the telephony gateway 130 attempts to recognize the spoken request within a predetermined time interval and above a predetermined level of accuracy. If the speech recognition engine 135 is capable of recognizing the spoken request above the predetermined level of accuracy, the telephony gateway 130 communicates data describing the content of the request to the service provider engine 274.

If the speech recognition engine 135 is unable to recognize the spoken request above the predetermined level of accuracy, the speech recognition engine 135 communicates the request to the service provider engine 274 via the telephony gateway interface 236 and the directory gateway server 140. In addition to the spoken request, the speech recognition engine 135 may communicate one or more suggestions as to the content of the request to the service provider engine 274.

The service provider engine 274 may match the phone number of the voice connection with the phone number of the data connection to identify the location of the user A 105A. The service provider engine 274 then requests an available level one agent A 110A from the task distribution engine 150. The current location of the user A 105A may also be communicated to the task distribution engine 150 in order to identify the agents 110A-N, 120A-N who may be familiar with the geographic area corresponding to the current location of the user A 105A. The service provider engine 274 may also retrieve the preferences of the user A 105A from the subscriber data store 295. The preferences of the user A 105A can include the language spoken by the user A 105A, or even the local dialect of the user A 105A. The language and local dialect preferences may also be communicated to the task distribution engine 274 to ensure the most efficient agents 110A-N, 120A-N for the user A 105A are selected.

The task distribution engine 150 then identifies an available level one agent A 110A best suited for recognizing the spoken request of the user A 105A. The service provider engine 274 communicates the spoken request to the identified level one agent A 110A via the directory gateway server 140. If the level one agent A 110A is able to recognize the spoken request the level one agent A 110A communicates data describing the content of the spoken request to the service provider engine 274. If the level one agent A 110A is unable to recognize the spoken request, or if a predetermined time limit has expired, a signal is communicated to the service provider engine 274 indicating that the level one agent A 110A was unable to recognize the spoken request.

If the level one agent A 110A is unable to recognize the spoken request, the service provider engine 274 requests an available level two agent A 120A from the task distribution engine 150. The task distribution engine 150 identifies an available level two agent A 120A best suited for speaking with the user A 105A. The service provider engine 274 then facilitates opening a voice connection between the identified level two agent A 120A and the user A 105A. The level two agent A 120A then engages in a conversation with the user A 105A to determine the content of the spoken request. Once the level two agent A 120A has determined the content of the spoken request, the voice connection can be terminated and the level two agent A 120A communicates data describing the content of the spoken request to the service provider 274. In an alternate embodiment, the voice connection is not terminated, and the level two agent A 120A and the user A 105A maintain voice communication while the level two agent A 120A communicates with the service provider engine 274.

Once the service provider engine 274 has received data describing the content of the recognized spoken request from either the speech recognition engine 135, a level one agent A 110A, or a level two agent 120A, the service provider engine 274 may match the phone number of the voice connection with the phone number of the data connection to identify the current location of the user A 105A. The service provider engine 274 then interfaces with the content provider 290 to retrieve data related to the spoken request of the user A 105A and/or the current location of the user A 105A. For example, if the user A 105A requested the nearest Chinese restaurant, the service provider engine 274 retrieves data describing the Chinese restaurant located closest to the current location of the user A 105A. The data may include driving directions, a map, a phone number of the Chinese restaurant, or any other information that may be of interest to the driver of a vehicle.

The service provider engine 274 then communicates the data to the telematics subsystem 260. The telematics subsystem 260 communicates the data to the user A 105A via the data connection to the mobile device 205A. The data can then be displayed on the mobile device 205A or communicated via BLUETOOTH to a component of the system 100 incorporated into the vehicle. The data can be displayed to the user A 105A on a display in the vehicle, or the data can be spoken to the user A 105A through text-to-speech technology.

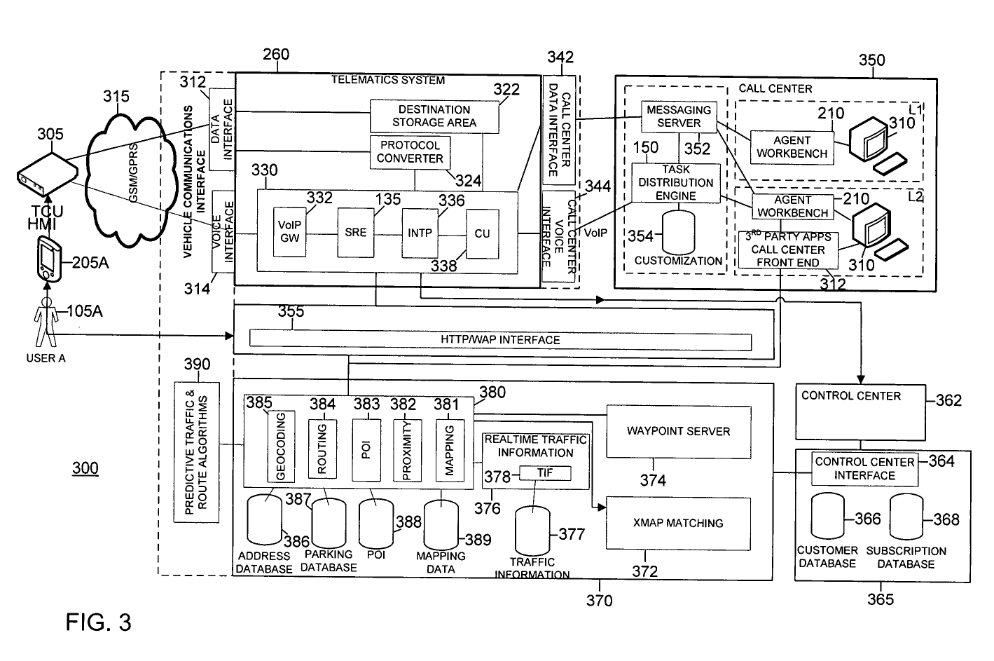

FIG. 3 illustrates an integration framework 300 of the system of FIG. 1, or other systems for processing a spoken request from a user. Not all of the depicted components are required, however, and some implementations may include additional components. Variations in the arrangement and type of the components may be made without departing from the spirit or scope of the claims as set forth herein. Additional, different or fewer components may be provided.

The integration framework 300 in this embodiment includes a user A 105A, a mobile device 205A, a telecommunication control unit (“TCU”) 305, a global system for mobile communications/general packet radio service (“GSM/GPRS”) data connection 315, a telematics subsystem 260, a call center 350, a hypertext transfer protocol/wireless application protocol (“HTTP/WAP”) interface 355, a control center 362, a control center subsystem 365, and a content provider system 370.

The telematics subsystem 360 includes a data interface 312, a voice interface 314, a destination storage area 322, a protocol converter 324, a speech subsystem 330, a call center data interface 342, and a call center voice interface 344. The telematics subsystem 360 provides mapping data to a driver of a vehicle, such as directions, points of interest, traffic information, or generally any information that may be of interest to the driver.

The speech subsystem includes a voice over internet protocol gateway (“VoIP GW”) 332, a speech recognition engine 135, an intercom profile (“INTP”) 336, and a control unit (“CU”) 338. The call center 350 includes one or more agent workbenches 210, a third-party application call center front-end 312, one or more computing devices 310, a messaging server 352, a task distribution engine 150, and a customization data store 354. The control center subsystem 365 includes a control center interface 364, a customer database 366, and a subscription database 368. The agent workbenches 210 do not need to be in a single location, and can be distributed geographically.

The content provider system 370 includes a waypoint server 374, an .xmap matching system 372, a real time traffic information subsystem 376, a traffic information database 377, a location information subsystem 380, an address database 386, a parking database 387, a point of interest (“POI”) database 388, a mapping database 389, and a predictive traffic and route algorithm processor 390. The location information subsystem 376 includes a geocoding component 385, a routing component 384, a POI component 383, a proximity component 382, and a mapping component 381. The content provider system 370 provides data, such as mapping data, to the telematics subsystem 260. The telematics subsystem 260 provides data to the user A 105A.

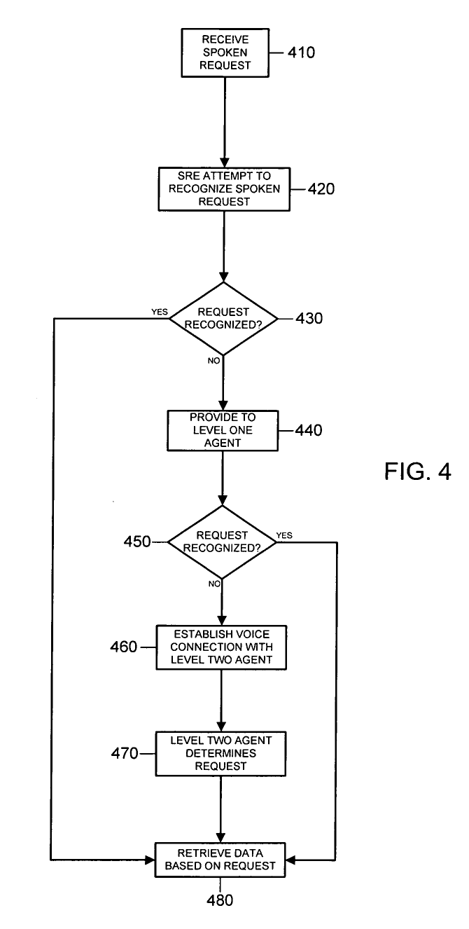

FIG. 4 is a flowchart illustrating the operations of the system of FIG. 1, or other systems for processing a spoken request from a user, wherein two levels of agents are utilized. At block 410, the telephony gateway 130 receives a spoken request for information from the user A 105A, such as a request for the location of a nearby business. At block 420, the speech recognition engine 135 attempts to recognize the spoken request within a predetermined time interval and above a predetermined level of accuracy. At block 430, the system 100 determines whether the speech recognition engine 135 was able to recognize the spoken request above the predetermined level of accuracy.

If, at block 430, the system 100 determines that the speech recognition engine 135 was not able to recognize the spoken request above the predetermined level of accuracy, the system 100 moves to block 440. At block 440, the system 100 provides the spoken request to the level one agent A 110A via the directory gateway server 140. If the speech recognition engine 135 recognizes the spoken request below the predetermined level of accuracy, the phrase recognized by the speech recognition engine 135 may also be communicated to the level one agent A 110A.

At block 450, the system 100 determines whether the level one agent A 110A was able to recognize the request. The level one agent A 110A may have a predetermined amount of time to determine whether they can recognize the spoken request. If the level one agent A 110A does not recognize the spoken request, or if the time limit expires, the system 100 moves to block 460. At block 460, the system 100 establishes a voice connection between the user A 105A and the level two agent A 120A. The voice connection is established by a VoIP connection. The voice connection allows the user A 105A to speak directly to the level two agent A 120A. Once the voice connection is established, the system 100 moves to block 470.

At block 470, the level two agent A 120A determines the content of the spoken request by engaging in a conversation with the user A 105A. The user A 105A may be able to better elaborate the request by speaking directly with the level two agent A 120A. Once the level two agent A 120A is able to recognize the spoken request, the system 100 moves to block 480. At block 480, the system 100 retrieves data based on the content of the spoken request. The data may be retrieved from a third party server, such as a content provider 290. The system 100 then communicates the data to the user A 105A.

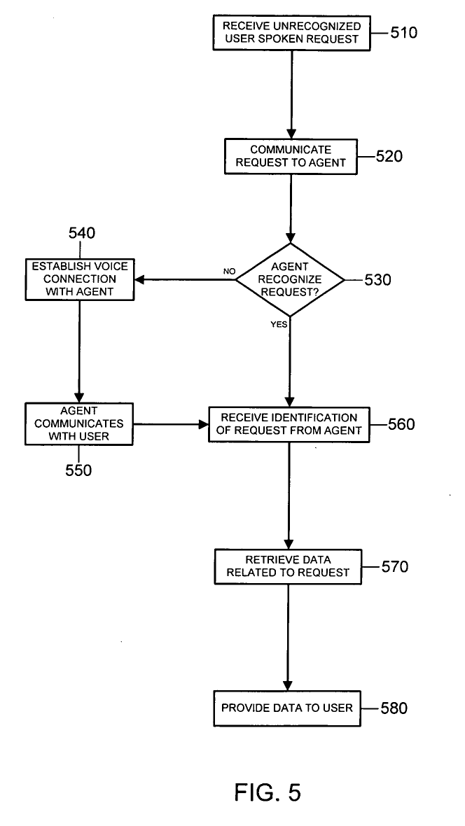

FIG. 5 is a flowchart illustrating the operations of the system of FIG. 1, or other systems for processing a spoken request from a user, wherein one level of agent is utilized. At block 510, the system 100 receives an unrecognized user spoken request where a speech recognition engine 135 was previously unable to recognize the request. At block 520, the directory gateway server 140 communicates the spoken request to a level one agent A 110A. The directory gateway server 140 requests an address of an available level one agent A 110A from the task distribution engine 150. At block 530, the system 100 determines whether the level one agent A 110A recognizes the spoken request. The level one agent A 110A may have a predetermined time interval to recognize the spoken request. If the time limit elapses, or if the level one agent A 110A indicates that they can not recognize the request, the system 100 moves to block 540. At block 540, the system 100 establishes a voice connection between the user A 105A and the level one agent A 110A. The voice connection may be a VoIP connection or may be traditional phone line connection.

At block 550, the level one agent A 110A communicates directly with the user A 105A. The user A 105A may be better able to articulate or expand upon the spoken request by communicating directly with the level one agent A 110A. Once the level one agent A 110A has understood the spoken request, the voice connection may be terminated, and the system 100 moves to block 560. In an alternate embodiment, the voice connection is not terminated, and the level two agent A 120A and the user A 105A maintain voice communication while system 100 moves to block 560.

If, at block 530, the level one agent A 110A recognizes the request, the system 100 moves to block 560. At block 560, the system 100 receives data describing the content of the spoken request from the level one agent A 110A. At block 570, the system 100 retrieves data related to the spoken request, such as by retrieving data from a third party content provider 290. At block 580, the system 100 provides the retrieved data to the user A 105A, such as by communicating the data to the user A 105A through a data connection. The data can be displayed to the user A 105A on a display in the vehicle, or the data can be spoken to the user A 105A through text-to-speech technology.

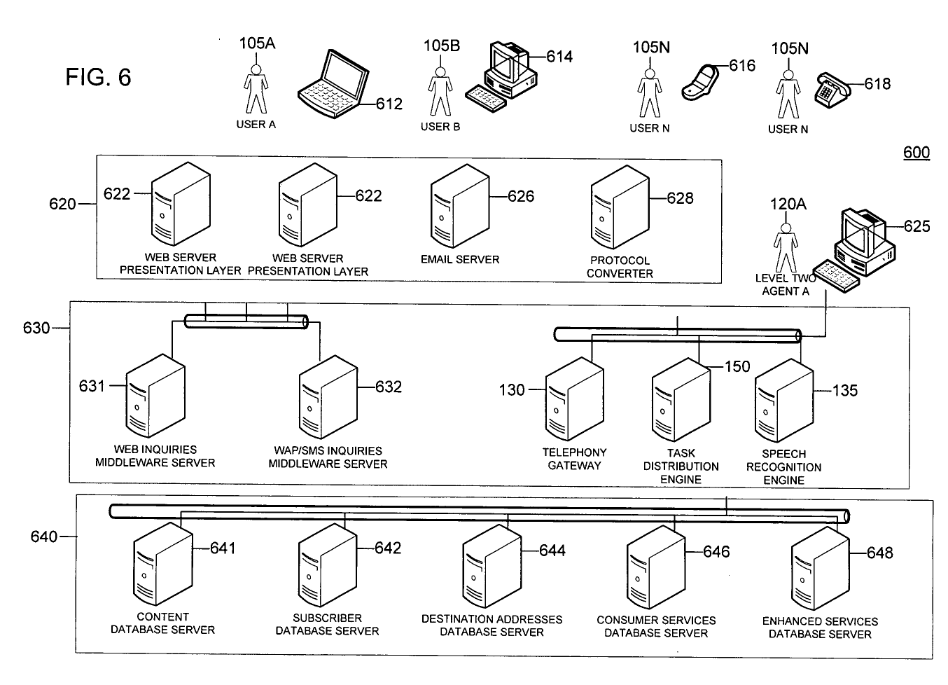

FIG. 6 illustrates a multi-tier implementation 600 of the system of FIG. 1, or other systems for processing a spoken request from a user. Not all of the depicted components are required, however, and some implementations may include additional components. Variations in the arrangement and type of the components may be made without departing from the spirit or scope of the claims as set forth herein. Additional, different or fewer components may be provided.

The multi-tier implementation 600 in this embodiment includes one or more users 105A-N, a portable computing device 602, a computing device 603, a mobile device 606 and a landline telephone 608, a level two agent A 120A, a agent computing device 625, a presentation tier 620, a middleware tier 630, and a data tier 640. The presentation tier 620 includes one or more web server presentation layers 622, an email server 626, and a protocol converter 628. The middleware tier 630 includes a web inquiries middleware server 631, a WAP/short messaging service (“WAP/SMS”) inquiries server 632, a telephony gateway 130, a task distribution engine 150, and a speech recognition engine 135. The data tier 640 includes a content database server 641, a subscriber database server 642, a destination addresses database server 644, a consumer services database server 646, and an enhanced services database server 648.

In operation, the presentation tier 620 provides the presentation of the data to the users 105A-N. The protocol converter 628 converts the data into a format that is best suited for the interaction device of a particular user N 105N. For example, if the user N 105N is interacting with the system though a landline telephone 608, data may be converted to speech and spoken to the user N 150N. The web server presentation layers 622 may also present data to the users 105A-N via web pages or mobile web pages.

The middleware layer 630 provides middleware services to the system 100. The web inquiries middleware server 631 and the WAP/SMS inquiries middleware server 632 receive input from the users 105A-N in the form of text messages, web request, mobile web request, or any other type of request capable of being communicated to the servers 631, 632. The telephony gateway 130 maintains the voice interface to the users 105A-N. The task distribution engine 150 distributes tasks amongst the agents 110A-N, 120A-N, such as the level two agent A 120A. The level two agent A 120A is able to interface with any of the input points to assist the users 105A-N. For example, if the user N 105N were to make a request via a mobile message, and the user N 105N made a spelling error in the request, the level two agent A 120A may be capable of correcting the spelling error.

The data tier 640 stores all of the data related to the system 100. The content database server 641 stores the content data, such as maps, points of interest, or any other content relating to the particular implementation of the system 100. The subscriber database server 642 stores the information related to the subscribers of the system 100, such as their language and dialect preferences. The destination addresses database server 644 stores the physical addresses of locations the users 105A-N frequently visit, such as the home address of the users 105A-N. The consumer services database server 646 provides consumer services to the users 105A-N, such as providing advertisements to the users 105A-N related to the information requested to the users 105A-N. The enhanced services server 648 provides enhanced services to the users 105A-N, such as traffic information, sports scores, stock tickers, or any other information that may be of interest to one of the users 105A-N of the system 100.

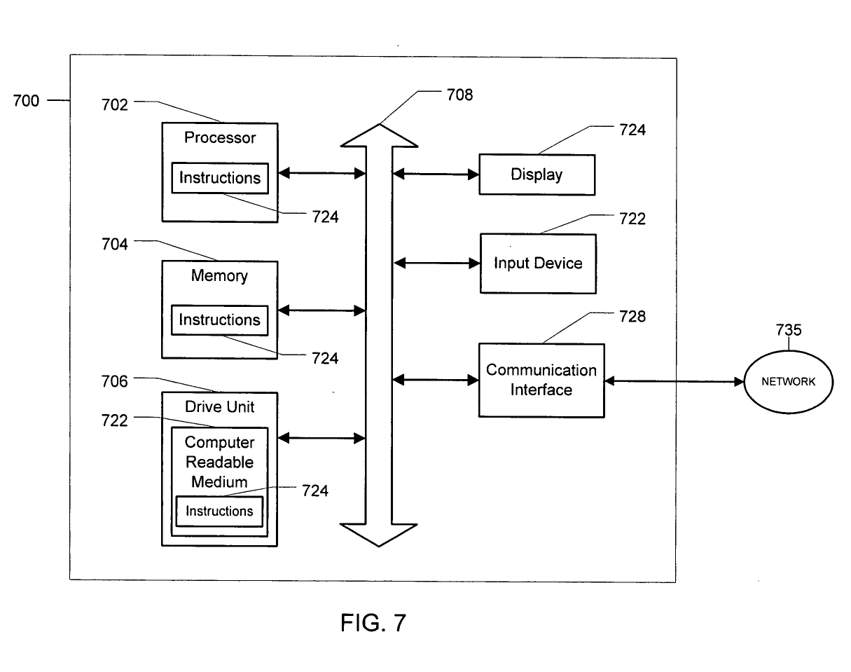

FIG. 7 illustrates a general computer system 700, which may represent a directory gateway server 140, a telephony gateway 135, a task distribution engine 150, or any other of the computing devices referenced herein. The computer system 700 includes a set of instructions 724 that may be executed to cause the computer system 700 to perform any one or more of the methods or computer based functions disclosed herein. The computer system 700 may operate as a standalone device or may be connected, e.g., using a network, to other computer systems or peripheral devices.

In a networked deployment, the computer system operates in the capacity of a server or as a client user computer in a server-client user network environment, or as a peer computer system in a peer-to-peer (or distributed) network environment. The computer system 700 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 724 (sequential or otherwise) that specify actions to be taken by that machine. In one embodiment, the computer system 700 is implemented using electronic devices that provide voice, video or data communication. Further, while a single computer system 700 is illustrated, the term “system” includes any collection of systems or sub-systems that individually or jointly execute a set, or multiple sets, of instructions to perform one or more computer functions.

As illustrated in FIG. 7, the computer system 700 includes a processor 702, such as a central processing unit (CPU), a graphics processing unit (GPU), or both. The processor 702 may be a component in a variety of systems. For example, the processor 702 may be part of a standard personal computer or a workstation. The processor 702 may also be one or more general processors, digital signal processors, application specific integrated circuits, field programmable gate arrays, servers, networks, digital circuits, analog circuits, combinations thereof, or other now known or later developed devices for analyzing and processing data.

The computer system 700 includes a memory 704 that can communicate via a bus 708. The memory 704 can be a main memory, a static memory, or a dynamic memory. The memory 704 can be any type of computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 704 includes a cache or random access memory for the processor 702. Alternatively, the memory 704 can be separate from the processor 702, such as a cache memory of a processor, the system memory, or other memory. The memory 704 could also be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 704 stores instructions 724 executable by the processor 702. The functions, acts or tasks illustrated in the figures or described herein may be performed by the programmed processor 702 executing the instructions 724 stored in the memory 704. The functions, acts or tasks can be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 700 further includes a display 714, such as a liquid crystal display (LCD), an organic light emitting diode (OLED), a flat panel display, a solid state display, a cathode ray tube (CRT), a projector, a printer or other now known or later developed display device for outputting determined information. The display 714 acts as an interface for the user to see the functioning of the processor 702, or specifically as an interface with the software stored in the memory 704 or in the drive unit 706.

Additionally, the computer system 700 includes an input device 712 configured to allow a user to interact with any of the components of system 100. The input device 712 can be a number pad, a keyboard, or a cursor control device, such as a mouse, or a joystick, touch screen display, remote control or any other device operative to interact with the system 100.

The computer system 700 may also include a disk or optical drive unit 706. The disk drive unit 706 includes a computer-readable medium 722 in which one or more sets of instructions 724, e.g. software, can be embedded. Further, the instructions 724 can perform one or more of the methods or logic as described herein. The instructions 724 may reside completely, or at least partially, within the memory 704 and/or within the processor 702 during execution by the computer system 700. The memory 704 and the processor 702 can also include computer-readable media as discussed above.

The present disclosure contemplates a computer-readable medium 722 that includes instructions 724 or receives and executes instructions 724 responsive to a propagated signal; so that a device connected to a network 735 may communicate voice, video, audio, images or any other data over the network 735. Further, the instructions 724 may be transmitted or received over the network 735 via a communication interface 718. The communication interface 718 may be a part of the processor 702 or may be a separate component. The communication interface 718 may be created in software or may be a physical connection in hardware. The communication interface 718 may be configured to connect with a network 735, external media, the display 714, or any other components in system 3000, or combinations thereof. The connection with the network 735 may be a physical connection, such as a wired Ethernet connection or may be established wirelessly as discussed below. Likewise, the additional connections with other components of the system 100 may be physical connections or may be established wirelessly. In the case of a directory gateway server 140 or a telephony gateway 135, the devices may communicate with the users 105A-N, level 1 agents 110A-N, and level 2 agents 120A-N through the communication interface 718.

The network 735 may include wired networks, wireless networks, or combinations thereof. The wireless network may be a cellular telephone network, an 802.11, 802.16, 802.20, or WiMax network. Further, the network 735 may be a public network, such as the Internet, a private network, such as an intranet, or combinations thereof, and may utilize a variety of networking protocols now available or later developed including, but not limited to TCP/IP based networking protocols.

The computer-readable medium 722 may be a single medium, or the computer-readable medium 722 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 722 may include a solid-state memory such as a memory card or other package that houses one or more non-volatile read-only memories. The computer-readable medium 722 also may be a random access memory or other volatile re-writable memory. Additionally, the computer-readable medium 722 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

What is claimed is:

1. A method for processing a spoken request from a user, the method comprising:
attempting to recognize a spoken request from a user with a speech recognition engine;
determining whether the speech recognition engine recognizes the spoken request above a predetermined level of accuracy;
providing the spoken request to a level one agent when the speech recognition engine does not recognize the spoken request above the predetermined level of accuracy; and
establishing a voice connection between the user and a level two agent when the level one agent does not recognize the spoken request.

2. The method of claim 1, wherein the level one agent must determine whether the spoken request is recognized within a predetermined time interval.

3. The method of claim 1 further comprising providing a response to the spoken request when the spoken request is recognized by one of the speech recognition engine, the level one agent, and the level two agent.

4. The method of claim 3, wherein the response comprises one of a voice response, a data response, a combined voice and data response, and an action.

5. The method of claim 1 further comprising establishing a data connection between a mobile device associated with the user and the level two agent.

6. The method of claim 1 further comprising establishing a data connection between a mobile device associated with the user and the level two agent.

7. The method of claim 1 further comprising reestablishing a voice connection if the established voice connection fails.

8. The method of claim 1 further comprising:
in response to the spoken request being recognized by one of the speech recognition engine, the level one agent, and the level two agent, providing a request for information to a content provider database, wherein a format for the request for information is the same irrespective of whether the spoken request is recognized by the speech recognition engine, the level one agent, or the level two agent.

9. A method for processing a spoken request from a user, the method comprising:
determining whether a silent response system comprising a speech recognition engine and a level one agent recognizes a spoken request from a user above a predetermined level of accuracy;
providing a response to the user when the silent response system recognizes the spoken request above the predetermined level of accuracy; and
establishing a voice connection between the user and a call center agent when the silent response system does not recognize the spoken request above the predetermined level of accuracy.

10. The method of claim 9, wherein determining whether the silent response system recognizes the spoken request above the predetermined level of accuracy comprises:
providing the spoken request to the speech recognition engine;
determining whether the speech recognition engine recognizes the spoken request above the predetermined level of accuracy; and
providing the spoken request to the level one agent when the speech recognition engine does not recognize the spoken request above the predetermined level of accuracy.

11. The method of claim 9, wherein the silent response system must determine whether the spoken request is recognized within a predetermined time interval.

12. The method of claim 11 further comprising:
providing feedback to the user during the predetermined time interval.

13. The method of claim 9 further comprising:
in response to the spoken request being recognized by one of the speech recognition engine, the level one agent, and the call center agent, providing a request for information to a content provider database, wherein a format for the request for information is the same irrespective of whether the spoken request is recognized by the speech recognition engine, the level one agent, or the call center agent.

14. A method for processing a spoken request from an operator of a vehicle, the method comprising:
with a speech recognition engine, attempting to recognize a spoken request from an operator of a vehicle, wherein the speech recognition engine is located remote from the vehicle;
determining whether the speech recognition engine recognizes the spoken request above a predetermined level of accuracy;
if the speech recognition engine does not recognize the spoken request above the predetermined level of accuracy, providing the spoken request to a level one agent, wherein the level one agent does not have a two-way voice connection with the operator of the vehicle;
if the level one agent does not recognize the spoken request, establishing a two-way voice connection between the operator of the vehicle and a level two agent; and
in response to the speech recognition engine, level one agent, or level two agent recognizing the spoken request, providing a response to the spoken request, wherein the response comprises a data response that is provided to a telematics system of the vehicle.

15. The method of claim 14, wherein the spoken request from the operator of the vehicle is provided through the telematics system of the vehicle.

16. The method of claim 14, wherein the spoken request from the operator of the vehicle is provided through a mobile device separate from the telematics system of the vehicle.

17. The method of claim 16, wherein the mobile device is operative to provide its position.

18. The method of claim 14, wherein the response further comprises a voice response.

19. A system for processing a spoken request from a user, the system comprising:
a spoken request intake mechanism comprising a speech recognition engine, a level one call center, and a level two call center;
an information database; and
an interface between the spoken request intake mechanism and the information database.

20. The system of claim 19, wherein the speech recognition engine is located remote from a vehicle.

21. The method of claim 19, wherein the spoken request intake mechanism is capable of both voice and data communication.

22. The method of claim 19, further comprising:
in response to the spoken request being recognized, providing a request for information to the information database, wherein a format for the request for information is the same irrespective of whether the spoken request is recognized by the speech recognition engine, the level one call center, or the level two call center.

23. A system for processing a spoken request from a user, the system comprising:
a speech recognition engine;
a level one call center;
a level two call center;
an information database;
an interface between the information database on one side and the speech recognition engine, the level one call center, and the level two call center on the other side; and
an integration framework that supports voice and data calls received from a user, wherein the integration framework comprises a task distribution engine that routes the voice and data calls to one or more of the speech recognition engine, the level one call center, and the level two call center.

24. The system of claim 23, wherein the interface sends requests to the information database and receives responses to the requests from the information database in a predetermined format.

25. The system of claim 23, wherein the task distribution engine routes the voice and data calls pursuant to a set of predetermined parameters.

26. A system for processing a spoken request from a user, the system comprising:
a speech recognition engine;
a directory gateway server in communication with the speech recognition engine; and
a task distribution engine in communication with the directory gateway server;
wherein, in response to the speech recognition engine failing to recognize a spoken request from a user above a predetermined level of accuracy, the directory gateway server is operative to provide the spoken request to an agent assigned by the task distribution engine.

27. The system of claim 26, wherein the agent serves both as a level one agent and a level two agent.

28. The system of claim 27, wherein when the agent serves as the level one agent, the agent does not have two-way voice connection with the user.

29. The system of claim 27, wherein when the agent serves as the level two agent, the agent has two-way voice connection with the user.

30. The system of claim 26, wherein the agent serves as a level one agent, and wherein a separate agent serves as a level two agent.

31. The system of claim 26 further comprising:
a service provider engine in communication with the task distribution engine and the directory gateway server, wherein the service provider engine is operative to query a content provider database to provide a response to the spoken request.
